(19) United States
(12) Patent Application Publication
(10) Pub. No.: US 2011/0246060 A1
(43) Pub. Date: Oct. 6, 2011

(54) NAVIGATION SYSTEM

(75) Inventor: Kouji SHIMIZU, Kariya-city (JP)

(73) Assignee: DENSO CORPORATION, Kariya-city (JP)

(21) Appl. No.: 13/070,072

(22) Filed: Mar. 23, 2011

(30) Foreign Application Priority Data
Mar. 31, 2010 (JP) 2010-82167

(51) Int. Cl. G01C 21/36

(52) U.S. Cl. 701/201

(57) ABSTRACT

A navigation system includes a distribution server and a navigation apparatus. In the distribution server, a branch road data extraction section extracts data on branch road shape graphic patterns necessary for preparing a direction guide map from a branch road data storage device; an arrangement designation data preparation section prepares an arrangement designation data which designates an arrangement mode of the extracted data on branch road shape graphic patterns; and a distribution section distributes the extracted data on branch road shape graphic patterns and the prepared arrangement designation data to the navigation apparatus. In the navigation apparatus, a direction guide map preparation section prepares a direction guide map based on the received data on branch road shape graphic patterns and the received arrangement designation data; and a direction guide map display section displays the prepared direction guide map in a display device.

### CROSS REFERENCE TO RELATED APPLICATION

The present application is based on and incorporates herein by reference Japanese Patent Application No 2010-82167 filed on Mar. 31, 2010.

### FIELD OF THE INVENTION

The present invention relates to a navigation system having a navigation apparatus and a distribution server. The navigation apparatus displays a direction guide map illustrating information about branch roads deriving from a branch point that is in a travel route of a vehicle. The distribution server distributes data for displaying the direction guide map, to the navigation apparatus.

### BACKGROUND OF THE INVENTION

[Patent document 1] JP-2008-45925 A

Patent document 1 discloses a navigation system in which a direction guide map is displayed when a vehicle approaches a branch road. The direction guide map illustrates (i) a graphic such as a crossroad or Y junction expressing a shape of a branch point, and names indicating directions to which respective branch roads advance, such as names of cities, towns, or villages that are located in the directions in which many vehicles advance, for instance. When a direction guide map contains a graphic or drawing indicating a shape of a branch point and a name relative to a heading direction of a branch road, the data volume of the direction guide map tends to be great. Therefore, when such a great data volume is distributed from a distribution server, a communications charge or a communications time is increased. In contrast, even if such a great data volume is previously stored in a navigation apparatus, a great deal of memory of the navigation apparatus needs to be used, thereby posing another disadvantage to cause a capacity lack in the memory.

### SUMMARY OF THE INVENTION

It is an object of the present invention to provide a navigation system, which displays in a navigation apparatus a direction guide map indicating information relative to a branch road included in a branch point by transmitting information relative to the direction guide map to the navigation apparatus from a distribution server, the system being capable of reducing a data volume of the information in the transmission from the distribution server to the navigation apparatus.

To achieve the above object, according to an embodiment of the present invention, a navigation system having a navigation apparatus in a vehicle and a distribution server outside of the vehicle is provided as follows. The navigation apparatus displays a direction guide map of a branch point that exists within a travel route of the vehicle when the vehicle approaches the branch point. The direction guide map indicates information relative to branch roads included in the branch point. The distribution server distributes to the navigation apparatus data necessary for displaying the direction guide map of the branch point. A branch point specification information transmission section is provided in the navigation apparatus to transmit, to the distribution server, branch point specification information that specifies a branch point whose direction guide map is to be displayed. A branch road data storage device is provided in the distribution server to store branch road data prepared for every branch road which is included in the branch point. A branch point specification information reception section is provided in the distribution server to receive the branch point specification information transmitted by the branch point specification information transmission section. A branch road data extraction section is provided in the distribution server to specify a target branch point whose direction guide map is to be displayed based on the received branch point specification information, and to extract, from the branch road data storage device, branch road data which are necessary for preparing the direction guide map of the target branch point. An arrangement designation data preparation section is provided in the distribution server to prepare arrangement designation data that designates an arrangement mode of the branch road data in the direction guide map of the target branch point. A distribution section is provided in the distribution server to distribute the extracted branch road data and the prepared arrangement designation data to the navigation apparatus in association with the branch point specification information that specifies the branch point whose direction guide map is to be displayed. A direction guide map preparation section is provided in the navigation apparatus to prepare the direction guide map of the branch point, which is specified by the branch point specification information, based on the branch road data and the arrangement designation data, which are received from the distribution section of the distribution server. A direction guide map display section is provided in the navigation apparatus to display the prepared direction guide map of the branch point that is specified by the branch point specification information.

That is, the data distributed from the distribution server to the navigation apparatus for displaying a direction guide map contain (i) branch road data necessary for preparing a direction guide map out of all the branch road data that are prepared for every branch road, and (ii) arrangement designation data which designates an arrangement mode in the direction guide map of the branch road data. This can reduce the data volume necessary for distributing from the distribution server to the navigation apparatus in order to display a direction guide map; the reduction in communications charges or hours can be attained.

According to another example of the present invention, a method for displaying a direction guide map of a branch point in a navigation apparatus that is in a vehicle and included in a navigation system is provided as follows. The navigation system further includes a distribution server that is outside of the vehicle to store data on graphic patterns of shapes of branch roads included in the branch point and distribute to the navigation apparatus data necessary for displaying the direction guide map of the branch point. The method includes the following: determining, in the navigation apparatus, branch point specification information that specifies a branch point whose direction guide map is to be displayed; transmitting the determined branch point specification information from the navigation apparatus to the distribution server; extracting, in the distribution server, from the branch road data storage device, data on graphic patterns of shapes of branch roads that are necessary for preparing the direction guide map of the branch point, which is specified by the received branch point information; preparing, in the distribution server, an arrangement mode that indicates a position and a direction of each of the extracted graphic patterns in the direction guide map of the branch point; transmitting the extracted data on graphic patterns of shape of the branch roads and the prepared arrangement mode from the distribution server to the navigation apparatus; preparing, in the navigation apparatus, the direction guide map of the branch point, which is specified by the branch point specification information, such that each of graphic patterns of shapes of the branch roads indicated by the received data on graphic patterns is arranged in the direction guide map based on the position and direction indicated by the received arrangement mode; and displaying, in the navigation apparatus, the prepared direction guide map of the branch point that is specified by the branch point specification information.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of a navigation system according to a first embodiment of the present invention;

FIG. 2 is a diagram illustrating branch road data;

FIG. 3 is a flowchart illustrating a control process;

FIG. 4 is a diagram illustrating an example of a display window in a display device at the time prior to displaying a direction guide map;

FIG. 5 is a diagram illustrating an example of a direction guide map;

FIG. 6 is a diagram illustrating an example of a display window containing a direction guide map in the display device; and

FIG. 7 is a block diagram illustrating a configuration of a navigation system according to a second embodiment of the present invention.

### DETAILED DESCRIPTION OF THE PREFERRED EMBODIMENTS

### First Embodiment

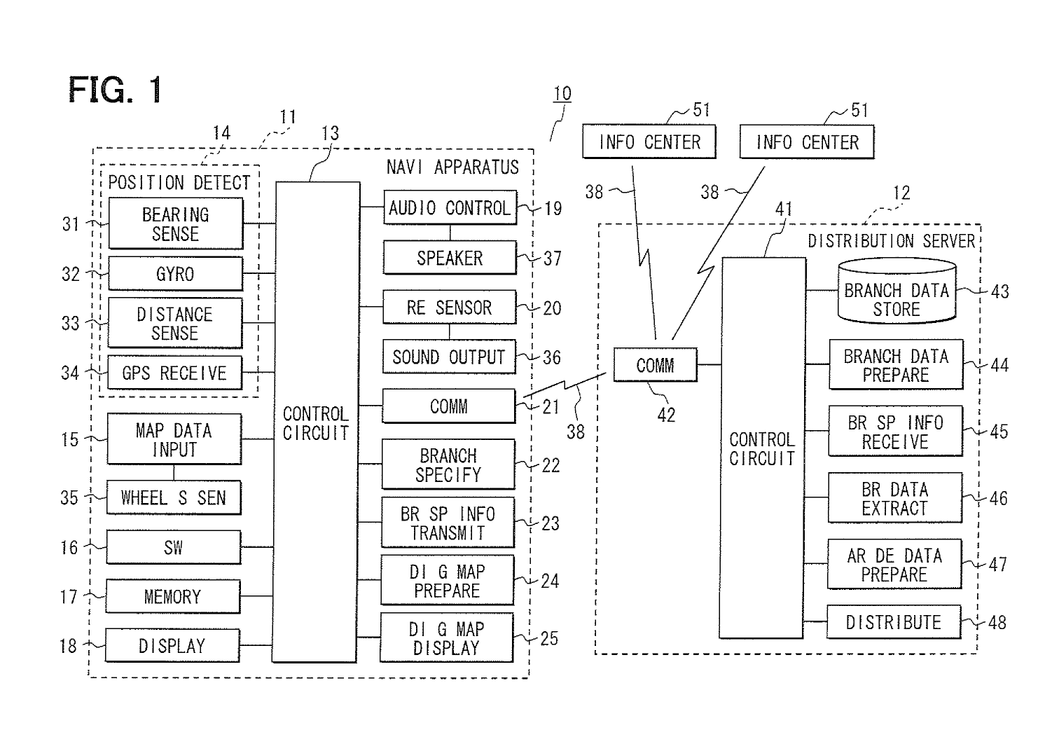

The following explains a first embodiment of the present invention with reference to FIGS. 1 to 6. FIG. 1 is a functional block diagram illustrating an overall configuration of a navigation system 10. The navigation system 10 includes a navigation apparatus 11 and a distribution server 12. The navigation apparatus 11 is mounted in a subject vehicle. The navigation apparatus 11 includes a control circuit 13, a position detection device 14, a map data input device 15, a manipulation switch device 16, an external memory 17, a display device 18, an audio controller 19, a remote control sensor 20, and a communications device 21. The control circuit 13 includes mainly a microcomputer having a CPU, ROM, and RAM (none shown). In the navigation apparatus 11, the CPU of the control circuit 13 executes a control software program, thereby achieving a branch point specification section 22, a branch point specification information transmission section 23, a direction guide map preparation section 24, and a direction guide map display section 25.

The position detection device 14 detects a present position of the vehicle which carries the navigation apparatus 11. The position detection device 14 includes a direction sensor 31, a gyro sensor 32 (gyroscope), a distance sensor 33, and a GPS receiver 34. The direction sensor 31 detects a bearing of the vehicle. The gyro sensor 32 detects a turning angle of the vehicle. The distance sensor 33 detects a travel distance of the vehicle. The GPS receiver 34 receives an electric wave transmitted from a GPS satellite (unshown) in order to carry out positioning of a present position of the vehicle using the GPS (Global Positioning System). The map data input device 15 acquires map data from a map data storage portion 35. The map data stored in the map data storage portion 35 is read by a drive device (unshown) into the map data input device 15. The map data storage portion 35 includes, for instance, a large data volume storage media such as a DVD, CD, memory card, or hard disk drive.

The map data stored in the map data storage portion 35 is beforehand provided using the DVD or the hard disk drive, or beforehand distributed from the distribution server 12. The map data include various kinds of data such as road data containing data of nodes and links connecting the nodes, landmark data, map matching-use data, destination data, and table data for transforming traffic information into road data. Further, the map data include coordinate information on branch point existing on a map (branch point included in the map data), branch point shape information for specifying a shape of each branch point (e.g., crossroad, Y junction, or three-forked road, etc.), point information (names of cities, towns, and villages; and facility names; place names; etc.). In addition, the map data include branch point numbers and guide area numbers. The branch point number corresponds to and is assigned to a position of each branch point of a road existing on a map to specify the position of the branch point. The guide area number corresponds to and is assigned to a position or area of each guide area to specify the point or area of the guide area. The guide area is an area covering a predetermined range containing each branch point. When the vehicle enters a guide area, a direction guide map is displayed in the display device 18.

The manipulation switch device 16 includes a mechanical switch formed near a display screen of the display device 18 and a touch panel switch formed on the screen of the display device 18. The switches of the manipulation switch device 16 are used for a user to input various commands or instructions to execute designation of a destination or a switchover of display windows or display manners of the display device 18 such as a changeover of map scales, selection of menu windows, route retrieval, start of route guidance, correction of a present position, and adjustment of audio volume. Thereby, the navigation apparatus 11 operates according to the user's instructions. The remote control sensor 20 transmits and receives various kinds of manipulation signals with the remote control 36. Several manipulation switches are formed in the remote control 36. By manipulating the manipulation switch of the remote control 36, various kinds of command signals are transmitted to the control circuit 13 via the remote control sensor 20 from the remote control 36. By manipulating either the manipulation switch device 16 or the remote control 36, the control circuit 13 is caused to execute identical functions.

The external memory 17 includes a flash memory card, which can be detached and attached, or a hard disk drive, for example. Alternatively, the external memory 17 may be achieved by a portion of the map data storage portion 35, or a portion of the RAM or EEPROM provided in the control circuit 13 of the navigation apparatus 11. The display device 18 includes a color display of a liquid crystal or an organic electroluminescence, for example. The screen of the display device 18 displays a map window or map surrounding a present position of the vehicle in various scales while superimposing on the map a present position mark indicating a present position and heading direction of the vehicle. In addition, when executing route guidance to a destination, the screen of the display device 18 displays a window for the route guidance.

The audio controller 19 is connected to an in-vehicle speaker 37. The audio controller 19 outputs a sound output signal to the in-vehicle speaker 37 based on a sound output signal from the control circuit 13. Sounds outputted via the in-vehicle speaker 37 include a sound about guidance, a sound about manipulation manual, a sound reporting that a theft preventive function is working, and a talk-back sound according to a speech recognition result.

The control circuit 13 causes the screen of the display device 18 to display a road map surrounding a present position to enable the vehicle to travel along a travel route and superimpose a present position mark indicating a present position and heading direction of the vehicle. In such a case, the display of the present position moves along with a travel of the vehicle on the map displayed in the display device 18. The map displayed in the display device 18 is scrolled according to the present position of the vehicle. At this time, the control circuit 13 executes a map matching process which matches a present position of the vehicle on a road.

The communications device 21 executes data communications with the distribution server 12 via the communications link 38. In this case, the navigation apparatus 11 may have a configuration in which the data communications with the distribution server 12 is executed according to the manipulation via the manipulation switch device 16 or the remote control 36 by the user. Alternatively, the navigation apparatus 11 may have a configuration in which the data communications may be executed with the distribution server 12 automatically for every predetermined time using a timer. Further, both the above two configurations may be included in the navigation apparatus 11. The branch point specification section 22 specifies a branch point which exists in the heading direction of the vehicle. That is, the branch point specification section 22 compares the coordinate of the present position of the vehicle with the coordinate of the branch point included in the map data, and determines whether the present position of the vehicle approaches the branch point. In such a case, the branch point specification section 22 determines that the present position of the vehicle approaches the branch point when the coordinate of the present position of the vehicle enters a guide area including the branch point the coordinate of which is a comparison object. The branch point specification section 22 specifies the branch point as a target branch point whose direction guide map is to be displayed.

The branch point specification information transmission section 23 transmits the branch point specification information specified by the branch point specification section 22 to the distribution server 12 via the communications device 21. The specification information includes a position and shape of the branch point that the vehicle approaches. The branch point specification information transmission section 23 assigns the branch point specification information at least with a branch point number, which specifies the position of the branch point. Further, the branch point specification information transmission section 23 may assign the branch point specification information with a guide area number which specifies a position of a guide area containing a branch point or branch point shape information which specifies a shape of a branch point. The direction guide map preparation section 24 receives the branch road data and arrangement designation data, which are distributed by the distribution section 48 of the distribution server 12, via the communications device 21, and prepares a direction guide map based on the received branch road data and arrangement designation data. The direction guide map display section 25 displays the direction guide map prepared by the direction guide map preparation section 24 in superimposition on the map currently displayed in the display device 18.

The distribution server 12 is provided with the control circuit 41, the communications device 42, the branch road data storage device 43, etc. The control circuit 41 includes mainly a microcomputer having a CPU, ROM, and RAM (none shown). The distribution server 12 realizes the branch road data preparation section 44, the branch point specification information reception section 45, the branch road data extraction section 46, the arrangement designation data preparation section 47, and the distribution section 48 with software by executing a control software program in the CPU of the control circuit 41.

The communications device 42 executes data communications with the navigation apparatus 11 of each vehicle via the communications link 38. In addition, the communications device 42 executes data communications with several information centers 51 via the communications link 38, and acquires various kinds of information from the information centers 51. Several information centers 51 are arranged in correspondence to several regions, respectively. Each information center 51 holds information which is specialized in each region. The information held by the information center 51 in a certain region includes, with respect to the certain region, road traffic information such as congestion information and road regulation information, and branch road data corresponding to the shapes of branch points that exist in the certain region.

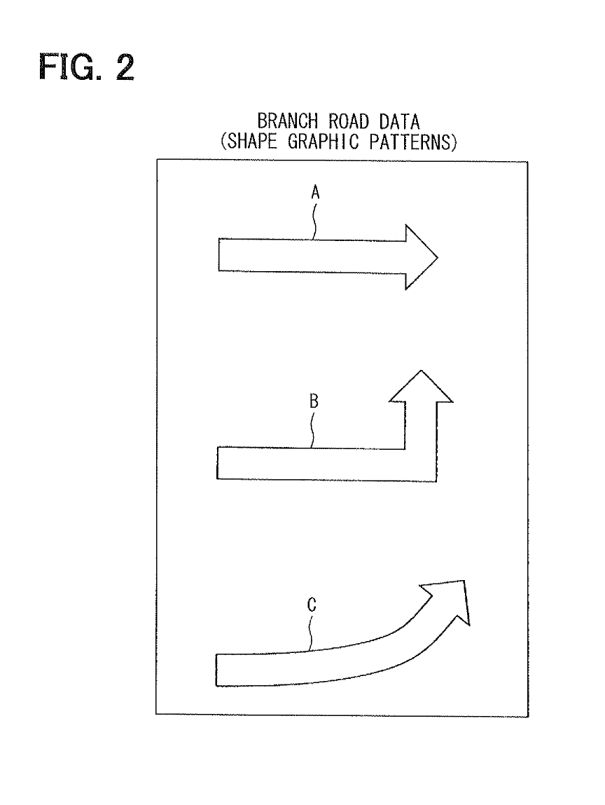

The branch road data preparation section 44 prepares branch road data for every branch road which is included in branch points existing on a map (all the branch points included in the map data). In such a case, the branch road data preparation section 44 prepares branch road data A, B, C illustrated in FIG. 2, for instance, by using a dedicated branch road data preparation software program based on an instruction of a system administrator or the like.

Further, the branch road data A, B, C may be referred to as examples of branch road shape graphic patterns for patterning shapes of all the branch roads included in all the branch points included in the map data, for example. In other words, the branch road data preparation section 44 prepares data on several branch road shape graphic patterns (i.e., image data instead of text data) so that shapes of all the branch roads in all the branch points included in the map data may be schematically illustrated in direction guide maps that are to be displayed in the display device 18 of the navigation apparatus 11. In such a case, the branch road data preparation section 44 prepares those data on the several branch road shape graphic patterns A, B, C illustrated in FIG. 2, for instance, by using a dedicated branch road data preparation software program based on an instruction of a system administrator or the like, as explained above. Further, the branch road shape graphic pattern also indicates as an arrow a direction of the branch road, as known from the branch data A, B, C in FIG. 2.

The branch road data storage device 43 is a database which stores or holds several branch road data (data on branch road shape graphic patterns) which are prepared for every branch road that is included in branch points. In such a case, the branch road data storage device 43 stores not only the branch road data prepared by the branch road data preparation section 44, but also the branch road data acquired from the information centers 51.

The branch point specification information reception section 45 receives the branch point specification information, which is transmitted by the branch point specification information transmission section 23 of the navigation apparatus 11, via the communications device 42. The branch road data extraction section 46 specifies the position of the branch point which is a target for displaying a direction guide map based on the branch point number contained in the branch point specification information received by the branch point specification information reception section 45 while specifying the shape of the branch point based on the map data (e.g., specifying necessary branch road shape graphic patterns). The branch road data extraction section 46 then extracts branch road data (e.g., data on branch road shape graphic patterns) required for preparing the direction guide map corresponding to the branch point from the branch road data storage device 43. In this case, when neither the guide area number nor branch point shape information is included in the received branch point specification information, the branch road data extraction section 46 may specify the position and shape of the branch point corresponding to the branch point number from the map data held by the distribution server 12 based on the received branch point number. In contrast, when the guide area number or branch point shape information is included in the received branch point specification information, the branch road data extraction section 46 make specify the position and shape of the branch point based on the received guide area number or branch point shape information.

The arrangement designation data preparation section 47 prepares arrangement designation data, which designates an arrangement mode in a direction guide map with respect to the branch road data (e.g., data on branch road shape graphic patterns) required for preparing the direction guide map (branch road data extracted by the branch road data storage device 43). This arrangement designation data is prepared as text data. The arrangement designation data contain (i) information which designates an arrangement mode of the branch road data (arrangement position and arrangement direction), (ii) names of points existing in the direction indicated by the branch road data arranged in the direction guide map (names of cities, towns, and villages; facility names; and place names); and (iii) information including time required to reach each point. The distribution section 48 distributes the branch road data extracted by the branch road data extraction section 46 and the arrangement designation data prepared by the arrangement designation data preparation section 47 to the navigation apparatus 11 via the communications device 42.

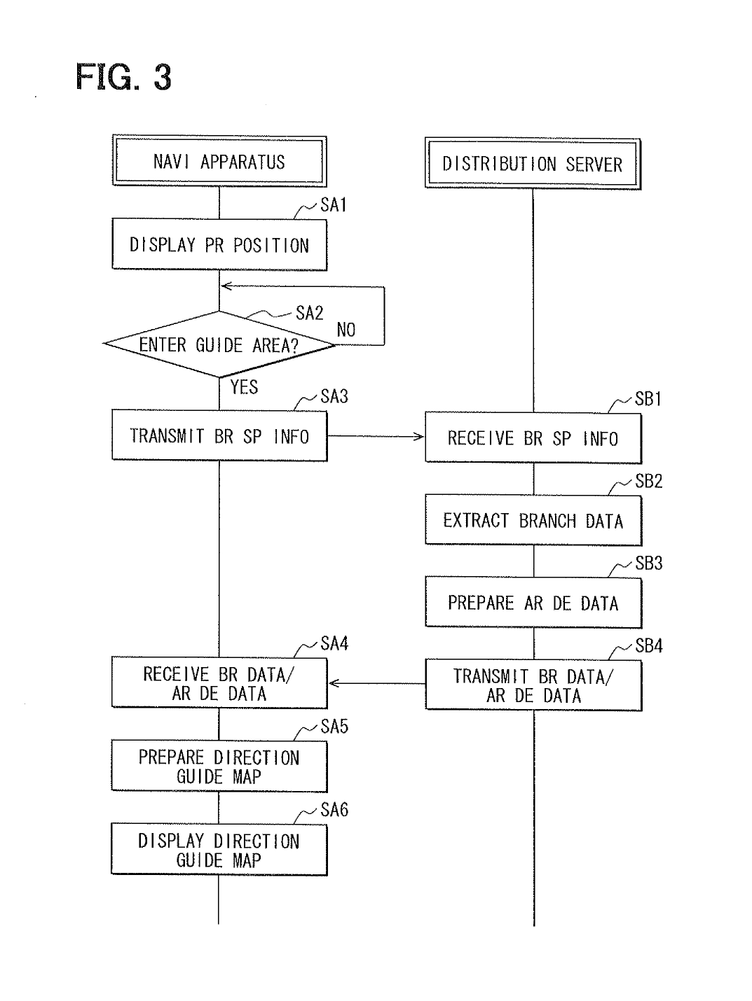

The following explains a control content of the navigation system 10, i.e., the control contents by the control circuit 13 of the navigation apparatus 11 and the control circuit 41 of the distribution server 12. FIG. 3 is a flowchart illustrating the control contents by the control circuit 13 of the navigation apparatus 11 and the control circuit 41 of the distribution server 12.

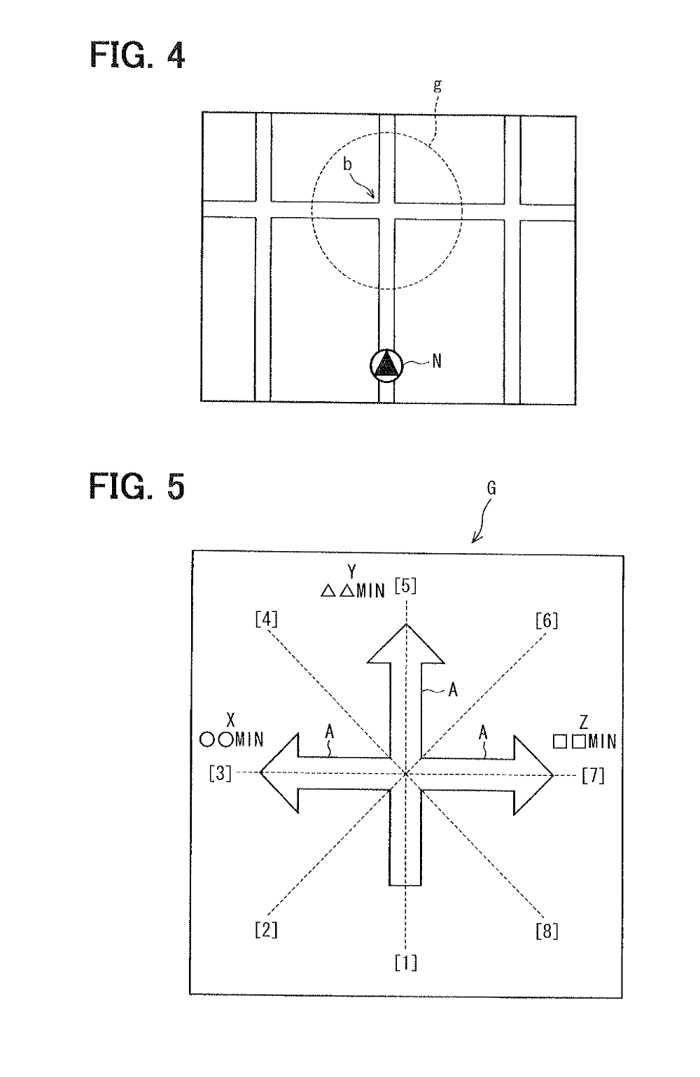

It is further noted that a flowchart or the processing of the flowchart in the present application includes sections (also referred to as steps), which are represented, for instance, as SA1 or SB1. Further, each section can be divided into several sub-sections while several sections can be combined into a single section. Furthermore, each of thus configured sections can be referred to as a means or unit and achieved not only as a software device but also as a hardware device. The control circuit 13 of the navigation apparatus 11 displays a present position N of the vehicle in superimposition on a map in the display device 18 (SA1), as illustrated in FIG. 4. The control circuit 13 determines whether the present position N of the vehicle enters a guide area g containing a branch point b which exists in the heading direction of the vehicle (SA2). When determining that the present position N of the vehicle enters the guide area g (SA2: YES), the control circuit 13 supposes that the present position N of the vehicle approaches the branch point b, thereby transmitting the branch point specification information which specifies the branch point b to the distribution server 12 (SA3).

When the control circuit 41 of the distribution server 12 receives the branch point specification information (SB1), the control circuit 41 extracts the branch road data (e.g., data on branch road shape graphic patterns) required for preparing the direction guide map corresponding to the branch point specified by the branch point specification information, from the branch road data storage device 43 (SB2). The branch point b is shaped of a crisscross in which three branch roads having linear shapes extend to three directions of the front, the left, and the right directions with respect to the heading direction (upward in FIG. 4) of the vehicle. Therefore, the branch road data required for preparing the direction guide map corresponding to the shape of the branch point b is a branch road data A (i.e., data on branch road shape graphic pattern A) of a linear shape illustrated in FIG. 2. Therefore, the control circuit 41 extracts the branch road data A from the branch road data storage device 43.

Then the control circuit 41 prepares the arrangement designation data which designates the arrangement mode in the direction guide map of the branch road data (i.e., three patterns A) required for preparing the direction guide map (SB3). In this case, the control circuit 41 adds the information which designates the arrangement mode (the arrangement position and arrangement direction) of the branch road data A to the arrangement designation data. The information designating the arrangement mode is as follows: “The branch road data A is arranged to face the left in the arrangement position [3] in the direction guide map,” “The branch road data A is arranged to face the front in the arrangement position [5] in the direction guide map,” or “The branch road data A is arranged to face the right in the arrangement position [7] in the direction guide map.” The control circuit 41 adds to the arrangement designation data the following: information which indicates the name of the point X existing in the left side of the branch point b and the travel time required from the branch point b to the point X, information which indicates the name of the point Y existing in the front side of the branch point b and the travel time required from the branch point b to the point Y, or information which indicates the name of the point Z existing in the right side of the branch point b and the travel time required from the branch point b to the point Z. The control circuit 41 distributes the branch road data extracted by the branch road data extraction section 46 and the arrangement designation data prepared by the arrangement designation data preparation section 47 to the navigation apparatus 11 via the communications device 42 (SB4).

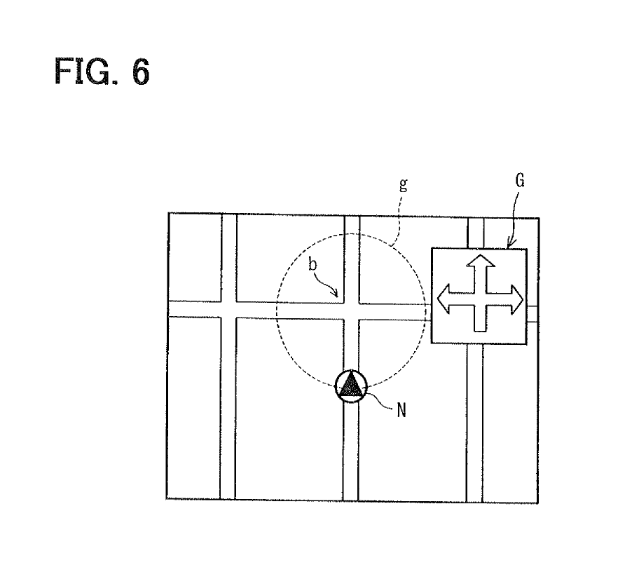

When the control circuit 13 of the navigation apparatus 11 receives the branch road data and arrangement designation data which are distributed from the distribution server 12 (SA4), the control circuit 13 prepares a direction guide map based on the received branch road data and arrangement designation data (SA5). In such a case, the control circuit 13 prepares a direction guide map G illustrated in FIG. 5 based on the branch road data and arrangement designation data. That is, the control circuit 13 arranges the branch road data A to face the left in the arrangement position [5], the branch road data A to face the front in the arrangement position [3], and the branch road data A to face the right in the arrangement position [7], respectively. The control circuit 13 arranges the name of the point X and the travel time required to the point X near the branch road data A in the arrangement position [3], the name of the point Y and the travel time required to the point Y near the branch road data A in the arrangement position [5], and the name of the point Z and the travel time required to the point Z near the branch road data A in the arrangement position [7]. The control circuit 13 displays the prepared direction guide map G in superimposition on the map currently displayed in the display device 18, as illustrated in FIG. 6 (SA6).

As explained above, according to the present embodiment, the data distributed from the distribution server 12 to the navigation apparatus 11 for displaying a direction guide map contain, (i) necessary branch road data (data on branch road shape graphic patterns) required for preparing the direction guide map out of all the branch road data (e.g., data on branch road shape graphic patterns) prepared for all the branch roads, and (ii) arrangement designation data for designating the arrangement mode in the direction guide map of the necessary branch road data. This can reduce the data volume necessary for distributing from the distribution server 12 to the navigation apparatus 11 in order to display a direction guide map; the reduction in communications charges or hours can be attained.

### Second Embodiment

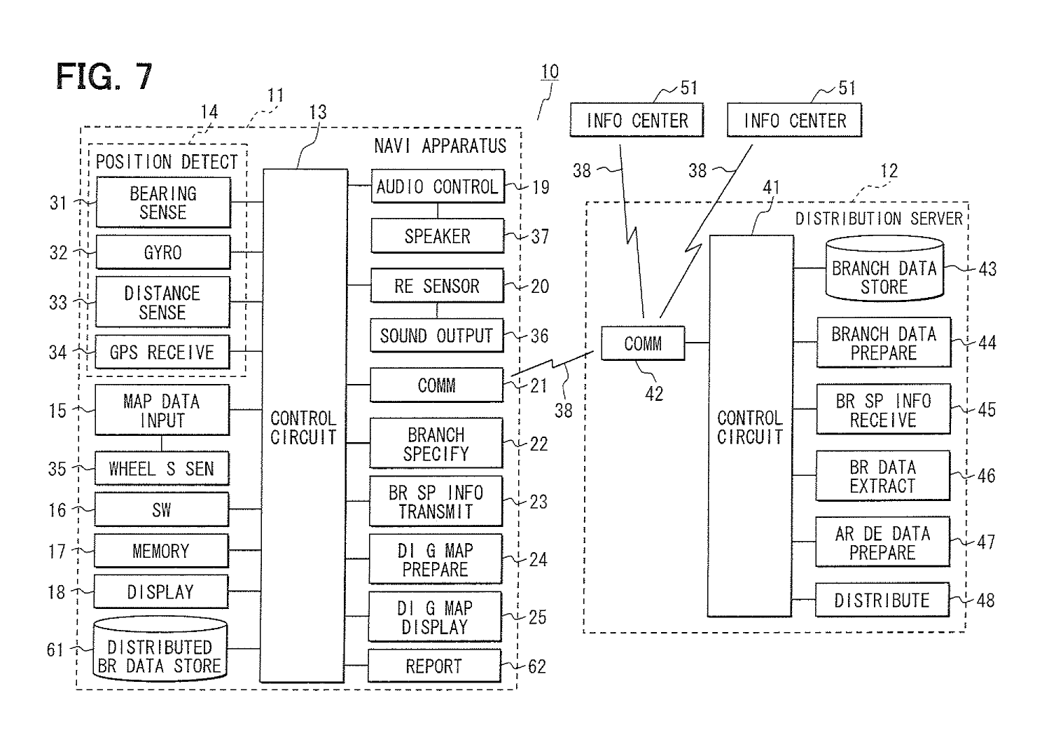

A second embodiment according to the present invention is explained with reference to FIG. 7. The present embodiment differs from the above first embodiment in that the control contents of the control circuit 13 of the navigation apparatus 11, and the control circuit 41 of the distribution server 12. The following explains only a portion different from the first embodiment. As illustrated in FIG. 7, in the present embodiment, the control circuit 13 of the navigation apparatus 11 is provided with a distributed branch road data storage device 61. The distributed branch road data storage device 61 is a database which stores the branch road data which the distribution section 48 of the distribution server 12 distributed as the distributed branch road data. The control circuit 13 stores the branch road data received from the distribution section 48 of the distribution server 12, in the distributed branch road data storage device 61 as distributed branch road data. In addition, the navigation apparatus 11 includes a report section 62 as a software program by executing a control program in the CPU of the control circuit 13. This report section 62 notifies the information which specifies the branch road data stored in the distributed branch road data storage device 61 as distributed branch road data to the distribution server 12 via the communications device 21.

The branch road data extraction section 46 of the distribution server 12 specifies the distributed branch road data already distributed to the navigation apparatus 11 based on the information received from the report section 62 of the navigation apparatus 11. The branch road data extraction section 46 then extracts, out of necessary branch road data required for preparing a direction guide map, branch road data other than the distributed branch road data, from the branch road data storage device 43. The arrangement designation data preparation section 47 prepares arrangement designation data which designates arrangement modes relative to the direction guide map of the necessary branch road data required for preparing the direction guide map. It is noted that the necessary branch road data contain (i) branch road data other than the distributed branch road data which are extracted at the present time from the branch road data storage device 43, and (ii) the distributed branch road data already distributed to the navigation apparatus 11. The distribution section 48 distributes (i) the branch road data extracted at the present time by the branch road data extraction section 46 (branch road data other than the distributed branch road data) and (ii) the arrangement designation data prepared by the arrangement designation data preparation section 47 to the navigation apparatus 11 via the communications device 42.

When receiving the arrangement designation data and the branch road data (branch road data other than the distributed branch road data) distributed from the distribution server 12, the control circuit 13 of the navigation apparatus 11 prepares a direction guide map based on (i) the received arrangement designation data, (ii) the received branch road data (branch road data other than the distributed branch road data), and (iii) the distributed branch road data stored in the distributed branch road data storage device 61. The control circuit 13 then displays the prepared direction guide map on the map currently displayed on the display device 18 in superimposition.

As explained above, according to the present embodiment, the repeated distribution of the branch road data which were once distributed to the navigation apparatus 11 can be made unnecessary. The data volume distributed from the distribution server 12 to the navigation apparatus 11 for displaying a direction guide map can be reduced. As a result, reduction in communications charges or hours can be attained more significantly.

### Other Embodiments

The present invention is not limited only to the above-mentioned embodiments, and can be modified or extended as follows. For instance, the navigation apparatus 11 may store previously template data of the direction guide map. In the template data of the direction guide map, the branch road data are arranged in all the arrangement positions [1]-[8] illustrated in FIG. 5. The distribution server 12 may add information, which specifies unnecessary branch road data out of the template data, to the arrangement designation data. That is, a configuration may be provided to prepare a direction guide map by deleting unnecessary branch road data.

Further, there may be existing a direction guide map having a complicated shape which cannot be prepared by using the branch road data (i.e., data on branch road shape graphic patterns) having comparatively simple shapes as illustrated in FIG. 2. Template data for such a complicated direction guide map may be previously stored in the navigation apparatus 11. In the navigation apparatus 11, a direction guide map may be prepared by deleting the unnecessary branch road data based on the arrangement designation data distributed from the distribution server 12. The information, which relates to each branch road included in a branch point and arranged in the direction guide map may need not be limited to names of points or travel time required to reach each point. For instance, various kinds of road traffic information (congestion information, traffic regulation information, etc.) may be displayed in the direction guide map.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a non-transitory computer-readable storage media or can be downloaded via a communications network and then stored in a non-transitory computer-readable storage media.

Aspects of the disclosure described herein are set out in the following clauses.

As an aspect of the disclosure, a navigation system having a navigation apparatus in a vehicle and a distribution server outside of the vehicle is provided as follows. The navigation apparatus displays a direction guide map of a branch point that exists within a travel route of the vehicle when the vehicle approaches the branch point. The direction guide map indicates information relative to branch roads included in the branch point. The distribution server distributes to the navigation apparatus data necessary for displaying the direction guide map of the branch point. A branch point specification information transmission section is provided in the navigation apparatus to transmit, to the distribution server, branch point specification information that specifies a branch point whose direction guide map is to be displayed. A branch road data storage device is provided in the distribution server to store branch road data prepared for every branch road which is included in the branch point. A branch point specification information reception section is provided in the distribution server to receive the branch point specification information transmitted by the branch point specification information transmission section. A branch road data extraction section is provided in the distribution server to specify a target branch point whose direction guide map is to be displayed based on the received branch point specification information, and to extract, from the branch road data storage device, branch road data which are necessary for preparing the direction guide map of the target branch point. An arrangement designation data preparation section is provided in the distribution server to prepare arrangement designation data that designates an arrangement mode of the branch road data in the direction guide map of the target branch point. A distribution section is provided in the distribution server to distribute the extracted branch road data and the prepared arrangement designation data to the navigation apparatus in association with the branch point specification information that specifies the branch point whose direction guide map is to be displayed. A direction guide map preparation section is provided in the navigation apparatus to prepare the direction guide map of the branch point, which is specified by the branch point specification information, based on the branch road data and the arrangement designation data, which are received from the distribution section of the distribution server. A direction guide map display section is provided in the navigation apparatus to display the prepared direction guide map of the branch point that is specified by the branch point specification information.

As an optional aspect, the navigation system may further include (i) a distributed branch road data storage device provided in the navigation apparatus to store as distributed branch road data the branch road data which are distributed from the distribution server; and (ii) a report section provided in the navigation apparatus to notify the distribution server of the distributed branch road data which is stored in the distributed branch road data storage device. Herein, the branch road data extraction section may be further configured to extract branch road data other than the distributed branch road data of which the report section notifies the distribution server out of the branch road data necessary for preparing the direction guide map in the navigation apparatus; the distribution section may be further configured to distribute the extracted branch road data other than the distributed branch road data to the navigation apparatus.

Thereby, the repeated distribution of the branch road data once distributed to the navigation apparatus can be made unnecessary. This can reduce the data volume necessary for distributing from the distribution server to the navigation apparatus in order to display a direction guide map; the reduction in communications charges or hours can be attained.

As an optional aspect of the navigation system, the branch road data stored in the branch road data storage device may indicate data on graphic patterns of shapes of the branch roads included in the branch point; and the arrangement mode of the branch road data designated by the arrangement designation data preparation section may include a position and a direction of each of the graphic patterns of shapes of the branch roads in the direction guide map of the branch point. Herein, the direction guide map preparation section of the navigation apparatus may be further configured to prepare the direction guide map of the branch point, which is specified by the branch point specification information, such that each of graphic patterns of shapes of the branch roads based on the received data on graphic patterns is arranged in the direction guide map based on the position and direction indicated by the received arrangement designation data.

According to another aspect of the disclosure, a method for displaying a direction guide map of a branch point in a navigation apparatus that is in a vehicle and included in a navigation system is provided as follows. The navigation system further includes a distribution server that is outside of the vehicle to store data on graphic patterns of shapes of branch roads included in the branch point and distribute to the navigation apparatus data necessary for displaying the direction guide map of the branch point. The method includes the following: determining, in the navigation apparatus, branch point specification information that specifies a branch point whose direction guide map is to be displayed; transmitting the determined branch point specification information from the navigation apparatus to the distribution server; extracting, in the distribution server, from the branch road data storage device, data on graphic patterns of shapes of branch roads that are necessary for preparing the direction guide map of the branch point, which is specified by the received branch point information; preparing, in the distribution server, an arrangement mode that indicates a position and a direction of each of the extracted graphic patterns in the direction guide map of the branch point; transmitting the extracted data on graphic patterns of shape of the branch roads and the prepared arrangement mode from the distribution server to the navigation apparatus; preparing, in the navigation apparatus, the direction guide map of the branch point, which is specified by the branch point specification information, such that each of graphic patterns of shapes of the branch roads indicated by the received data on graphic patterns is arranged in the direction guide map based on the position and direction indicated by the received arrangement mode; and displaying, in the navigation apparatus, the prepared direction guide map of the branch point that is specified by the branch point specification information.

It will be obvious to those skilled in the art that various changes may be made in the above-described embodiments of the present invention. However, the scope of the present invention should be determined by the following claims.

What is claimed:

1. A navigation system having a navigation apparatus in a vehicle and a distribution server outside of the vehicle,
the navigation apparatus displaying a direction guide map of a branch point that exists within a travel route of the vehicle when the vehicle approaches the branch point, the direction guide map indicating information relative to branch roads included in the branch point,
the distribution server distributing to the navigation apparatus data necessary for displaying the direction guide map of the branch point,
the navigation system comprising:
a branch point specification information transmission section provided in the navigation apparatus to transmit, to the distribution server, branch point specification information that specifies a branch point whose direction guide map is to be displayed;
a branch road data storage device provided in the distribution server to store branch road data prepared for every branch road which is included in the branch point;
a branch point specification information reception section provided in the distribution server to receive the branch point specification information transmitted by the branch point specification information transmission section;
a branch road data extraction section provided in the distribution server to
specify a target branch point whose direction guide map is to be displayed based on the received branch point specification information, and
extract, from the branch road data storage device, branch road data which are necessary for preparing the direction guide map of the target branch point;
an arrangement designation data preparation section provided in the distribution server to prepare arrangement designation data that designates an arrangement mode of the branch road data in the direction guide map of the target branch point;
a distribution section provided in the distribution server to distribute the extracted branch road data and the prepared arrangement designation data to the navigation apparatus in association with the branch point specification information that specifies the branch point whose direction guide map is to be displayed;
a direction guide map preparation section provided in the navigation apparatus to prepare the direction guide map of the branch point, which is specified by the branch point specification information, based on the branch road data and the arrangement designation data, which are received from the distribution section of the distribution server; and
a direction guide map display section provided in the navigation apparatus to display the prepared direction guide map of the branch point that is specified by the branch point specification information.

2. The navigation system according to claim 1, further comprising:
a distributed branch road data storage device provided in the navigation apparatus to store as distributed branch road data the branch road data which are distributed from the distribution server; and
a report section provided in the navigation apparatus to notify the distribution server of the distributed branch road data which is stored in the distributed branch road data storage device,
the branch road data extraction section being further configured to extract branch road data other than the distributed branch road data of which the report section notifies the distribution server out of the branch road data necessary for preparing the direction guide map in the navigation apparatus,
the distribution section being further configured to distribute the extracted branch road data other than the distributed branch road data to the navigation apparatus.

3. The navigation system according to claim, wherein:
the branch road data stored in the branch road data storage device indicate data on graphic patterns of shapes of the branch roads included in the branch point; and
the arrangement mode of the branch road data designated by the arrangement designation data preparation section include a position and a direction of each of the graphic patterns of shapes of the branch roads in the direction guide map of the branch point,
the direction guide map preparation section of the navigation apparatus being further configured to prepare the direction guide map of the branch point, which is specified by the branch point specification information, such that each of graphic patterns of shapes of the branch roads based on the received data on graphic patterns is arranged in the direction guide map based on the position and direction indicated by the received arrangement designation data.

4. A method for displaying a direction guide map of a branch point in a navigation apparatus that is in a vehicle and included in a navigation system, the navigation system further including a distribution server that is outside of the vehicle to store data on graphic patterns of shapes of branch roads included in the branch point and distribute to the navigation apparatus data necessary for displaying the direction guide map of the branch point,
the method comprising:
determining, in the navigation apparatus, branch point specification information that specifies a branch point whose direction guide map is to be displayed;
transmitting the determined branch point specification information from the navigation apparatus to the distribution server;
extracting, in the distribution server, from the branch road data storage device, data on graphic patterns of shapes of branch roads that are necessary for preparing the direction guide map of the branch point, which is specified by the received branch point information;
preparing, in the distribution server, an arrangement mode that indicates a position and a direction of each of the extracted graphic patterns in the direction guide map of the branch point;
transmitting the extracted data on graphic patterns of shape of the branch roads and the prepared arrangement mode from the distribution server to the navigation apparatus;
preparing, in the navigation apparatus, the direction guide map of the branch point, which is specified by the branch point specification information, such that each of graphic patterns of shapes of the branch roads indicated by the received data on graphic patterns is arranged in the direction guide map based on the position and direction indicated by the received arrangement mode; and
displaying, in the navigation apparatus, the prepared direction guide map of the branch point that is specified by the branch point specification information.
